(19) United States
(12) Patent Application Publication
(10) Pub. No.: US 2014/0169024 A1
(43) Pub. Date: Jun. 19, 2014

(54) REMOTE PHOSPHOR CONVERTER APPARATUS

(71) Applicant: OSRAM GmbH, Muenchen (DE)

(72) Inventors: Juergen Hager, Herbrechtingen (DE); Jasmin Muster, Heidenheim (DE); Oliver Hering, Niederstotzingen (DE)

(73) Assignee: OSRAM GmbH, Muenchen (DE)

(21) Appl. No.: 14/132,122

(22) Filed: Dec. 18, 2013

(30) Foreign Application Priority Data
Dec. 19, 2012 (DE) 10 2012 223 854.9

(51) Int. Cl. F21S 8/10; F21K 99/00

(52) U.S. Cl. CPC F21S 48/11; F21K 9/56
USPC 362/554; 362/84

(57) ABSTRACT

A remote phosphor converter apparatus may include a holder with at least one reference visible from the outside, at least one converter element held by the holder and at least one primary light emitter element which is held by the holder and configured to direct primary light emitted thereby to the converter element. An illumination device may include at least one remote phosphor converter apparatus.

### RELATED APPLICATIONS

The present application claims priority from German application No.: 10 2012 223 854.9 filed on Dec. 19, 2012, and is incorporated herein by reference in its entirety.

### TECHNICAL FIELD

Various embodiments relate to a remote phosphor converter apparatus, having a holder, at least one converter element held by the holder and at least one primary light emitter element which is held and configured to direct light emitted thereby to a converter element. Various embodiments can be applied in particular to motor vehicle illumination devices, in particular headlamps.

### BACKGROUND

An option for creating an illumination device emitting white light on the basis of semiconductor light sources lies in the directing of light (“primary light”) with a specific wavelength, the so-called primary wavelength or pump wavelength, emitted by LEDs to a converter element. The converter element has one or more phosphors which convert part of the incident primary light into light (“secondary light”) with a different, typically longer, wavelength. This wavelength conversion is set such that the converted light portion together with the remaining primary light portion provides white mixed light. The phosphor or the conversion-active material is in this case usually introduced into a light-transmissive support material, e.g. silicone, or embodied as ceramic phosphor. In most illumination devices, this converter element is fixedly attached to the light-producing LED chips. In general, the converter element has very similar lateral dimensions to an emission area of the LED chips, which is why the converter element can be used directly as light-technical reference for optical units.

In the case of semiconductor light sources, in which the conversion material is arranged at a distance from the semiconductor light sources (the so-called “remote phosphor” principle), there is no direct connection between the semiconductor light source(s) and the converter element. Moreover, the dimensions of the converter element can be larger than the region on which the primary light impinges. By way of example, a round light spot with a diameter of 0.6 mm, emitted by a semiconductor light source, e.g. a laser, may impinge on a square converter element with an edge length of 1 mm. It is therefore not expedient or not possible to make the light-technical reference dependent upon the converter element, for example because the converter is too large, has a coefficient of thermal expansion which is too large, etc. It follows that it is either necessary to accept large tolerances or very complicated adjustment processes are required to match the converter element and the light emitted by the semiconductor light source to one another.

### SUMMARY

Various embodiments provide an improved light-technical referencing of remote phosphor illumination devices.

Various embodiments provide a remote phosphor converter apparatus, having a holder with at least one reference visible from the outside, at least one converter element held by the holder and at least one primary light emitter element which is held by the holder and configured to direct primary light emitted thereby to a converter element.

An advantage of this device is that it enables simple mechanical handling and that the at least one converter element can likewise be positioned freely by aligning the converter apparatus. The tuning of the primary light emitter element then only still needs to be in respect of the reference marker and no longer in respect of the converter element due to the fixed positional relationship between the primary light emitter element and the converter element. Moreover, the size of the converter element can be varied without having to take light-technical or other effects into account. A form factor of the converter element can be the same for different light-technical requirements. As a result, e.g. fewer tools are required for the production, saving costs. The introduction of the reference further enables a floating mount of the converter element, for example to preclude problems due to thermal expansion. The size of the converter element can have much rougher tolerances than in the case of the usual white high-power LED light sources. As a result of the reference visible from the outside, an option is moreover provided to adjust the converter apparatus in terms of its position and alignment in a simple manner.

A remote phosphor converter apparatus is understood to mean, in particular, an apparatus in which a converter element is not arranged directly on a primary light emission area of a semiconductor light source, but rather at a distance therefrom (“remote phosphor”). Thus, in particular, the converter element is an independent element, which is also held independently by the holder.

A converter element is understood to mean, in particular, an element provided with one or more phosphors, which phosphor(s) sensitively reacts or react to primary light emitted by at least one semiconductor light source. The converter element may in particular emit mixed light made up of the primary light radiated thereon and wavelength-converted secondary light. Several converter elements may be arranged optically in series and/or in parallel. This may achieve a particularly varied composition of the mixed light. Several converter elements can have the same phosphor or different phosphors. The advantage emerging for different phosphors is that these can be thermally decoupled more strongly in this fashion.

A primary light emitter element is understood to mean, in particular, a single-part or multi-part element which can emit primary light, particularly into the holder.

An embodiment consists of the converter element being a converter transmitted-light element. As a result, it is possible to obtain a particularly compact design. The converter transmitted-light element is distinguished, in particular, by at least a portion of the primary light running through the converter transmitted-light element and, in the process, being partly converted into wavelength-converted secondary light. In this manner, the mixed light is typically emitted at a site differing from the light incidence area of the primary light. The light portion at this site differing from the light incidence area may, in particular, be greater than 50%, in particular greater than 80%, in particular greater than 90%, of the primary light originally radiated thereon. By way of example, if a phosphor plate is employed as converter transmitted-light element, the primary light is radiated onto one side and the mixed light (or used light) is emitted on the other side facing away therefrom.

A development consists of the converter element being a converter reflection element. Here, the mixed light is typically emitted from the same area onto which the primary light is radiated.

The converter apparatus may, in general, have at least one reflector for reflecting the primary light and/or the white mixed light. This enables a particularly complex design of the light emission pattern.

An embodiment consists of the at least one reference or “reference marker” being a reference element held by the holder. This also enables complex forming of the reference element in a simple manner, in particular a form which cannot readily be created as an integral region of the holder. Hence, such a reference element can, in particular, be produced separately and then be attached to the holder.

By way of example, the at least one reference element may be cast into the holder, adhesively bonded to the latter, latched thereon, clamped therein and/or pressed thereon, e.g. by a clamp or a clip.

Alternatively, or in addition thereto, the reference may be formed by a region of the holder as such. This region is, in particular, an integral or single-piece part of the holder and has not been produced separately therefrom. This may simplify production and enables a particularly securely arranged reference.

A further embodiment consists of the at least one reference being embodied as a stop for light emitted by the converter element. As a result of this, the light emitted by the converter apparatus can easily be shaped on the edge. A development preferred for complete edge-forming of the light emission pattern is that the stop is a pinhole.

The form of the stop may correspond to the form of the area from which the mixed light is emitted (“used light spot”), present on the converter element, e.g. it may be round or oval, or it may differ therefrom, e.g. it may be rectangular.

An even further embodiment consists of the at least one primary light emitter element having or being at least one optical fiber. That is to say, this primary light emitter element does not generate the primary light itself, but rather guides the primary light from at least one semiconductor light source to the at least one converter element. In particular, the at least one semiconductor light source can be arranged outside of the converter apparatus. Thus, in particular, an outside end of the at least one optical fiber is optically coupled to the at least one semiconductor light source and the other, inside end is directed to the at least one converter element. In particular, the inside end is held by and/or in the holder.

A development consists of the at least one optical fiber being exactly one optical fiber. This enables a particularly compact and cost-effective embodiment.

An even further development consists of the at least one optical fiber being an optical fiber bundle with several optical fibers. This enables a particularly varied form of the used light spot.

An embodiment also consists of the at least one optical fiber directly adjoining the converter element. This can achieve particularly precise positioning of the used light spot.

Moreover, an embodiment also consists of the at least one optical fiber being arranged at a distance from the converter element. This can avoid damage to or destruction of, in particular, thin converter elements.

An embodiment furthermore consists of the at least one primary light emitter element having at least one semiconductor light source which is arranged at a distance from the converter element. As a result, it is possible to dispense with an optical waveguide, which has advantages in respect of reduced unit costs and a reduced production complexity. Thus, in this case, the at least one semiconductor light source is held by the holder.

The semiconductor light source may be a laser, in particular a laser diode, which provides the advantage of a beam with only little divergence. Such an arrangement can also be referred to as LARP (“laser activated remote phosphor”). Particularly high luminance can be achieved by such arrangements compared to e.g. conventional LED technology.

The semiconductor light source may also be a so-called multi-die package, in which a multiplicity of laser diodes (referred to as multi-die here) are arranged on one or more substrate areas (“chip on submount”). The substrate areas are, in particular, arranged in a common housing (also referred to as “package”). Depending on the adjustment of the laser diodes or the substrate areas, this multi-die package can emit a bundle or array of laser beams offset in parallel, for example perpendicular to the base area of the multi-die arrangement or, in the case of a focusing adjustment, emit laser beams converging on a focus or several foci.

However, the semiconductor light source may also be a light-emitting diode (LED), in particular at least one LED chip.

Moreover, one embodiment consists of the holder holding at least one optical element arranged between the semiconductor light source and the converter element. This optical element enables a deflection and/or change in form of the primary light bundle emitted by the semiconductor light source. Such an embodiment is particularly advantageous in conjunction with at least one LED, in order to bundle or concentrate the primary light thereof in order to increase a light yield on the converter element.

By way of example, the at least one optical element may be embodied as at least one reflector and/or as at least one transmitted-light element, e.g. as a lens or optical collimator.

In general, at least one optical element may also be connected downstream of at least one converter element in order to form a used light bundle. By way of example, such an optical element may be a lens.

A further embodiment consists of the holder being an injection molded part. This enables a cost-effective production and flexible forming. It is particularly preferred if the holder consists of plastics. The parts held by the holder can then, in particular, be injected at holding regions or embedded into the holder. However, in principle, other production methods for the holder are also possible, e.g. adhesive bonding several separately produced parts of the holder.

An even further embodiment consists of the holder being embodied as a housing, in which the at least one converter element is accommodated and in which there is at least one light emergence opening or channel for light emitted by the at least one converter element. The housing results in particularly good protection of the elements or components accommodated therein. The light emergence opening may, in particular, be provided with a light-transmissive protective cover.

A further embodiment consists of the at least one reference being arranged in the region of the at least one light emergence opening. This supports an exact alignment of the used light beam. This also makes it possible to correlate the light emergence area of the primary light emitter element with the reference more easily.

Furthermore, an embodiment consists of the holder having at least one heat conducting element thermally connected to the at least one converter element. This improved cooling of the at least one converter element, thereby reducing the thermal load due to a “Stokes shift”, increasing a light yield and suppressing a shift of a sum color locus of the mixed light.

A development consists of the heat conducting element being arranged at least in part on the outside of the holder or being guided out of the holder. This enables particularly good thermal emission and handling. In particular, at least one guided-out region may be connected to a cooling body.

The heat conducting element may, in particular, consist of material with good thermal conduction properties with a thermal conductivity h of at least 15 W(m-K), e.g. of a metal such as aluminum or copper, of ceramic or of sapphire. The heat conducting element may for example have a plate-shaped design. For strong heat dissipation, the heat conducting element may, in particular, be in direct contact with the converter element.

Various embodiments also provide an illumination device, having at least one remote phosphor converter apparatus as described above. In particular, the remote phosphor converter apparatus can be produced or assembled separately and then be attached to the illumination device.

The illumination device may be a lamp, a luminaire or a light-emitting module. The illumination device may be provided, in particular, for use in motor vehicles, i.e., may be a motor vehicle illumination device in particular. The illumination device may in particular be a headlamp or constitute part of a headlamp.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows, as a sectional illustration and in a side view, a remote phosphor converter apparatus in accordance with a first exemplary embodiment;

FIG. 2 shows a frontal view against a light emission direction of the remote phosphor converter apparatus in accordance with the first exemplary embodiment;

FIG. 3 shows, as a sectional illustration and in a side view, a remote phosphor converter apparatus in accordance with a second exemplary embodiment;

FIG. 4 shows, as a sectional illustration and in a side view, a remote phosphor converter apparatus in accordance with a third exemplary embodiment;

FIG. 5 shows a frontal view of a remote phosphor converter apparatus in accordance with a fourth exemplary embodiment;

FIG. 6 shows, as a sectional illustration and in a side view, a remote phosphor converter apparatus in accordance with a fifth exemplary embodiment;

FIG. 7 shows a frontal view of a remote phosphor converter apparatus in accordance with a sixth exemplary embodiment;

FIG. 8 shows, as a sectional illustration and in a side view, a remote phosphor converter apparatus in accordance with a seventh exemplary embodiment;

FIG. 9 shows a frontal view of the remote phosphor converter apparatus in accordance with the seventh exemplary embodiment; and

FIG. 10 shows, as a sectional illustration and in a side view, a remote phosphor converter apparatus in accordance with an eighth exemplary embodiment.

### DETAILED DESCRIPTION

In general, “a”, “one”, etc. can be understood to mean a singular or plural, in particular within the meaning of “at least one” or “one or more”, etc., as long as this has not been explicitly excluded, for example by the expression “exactly one” etc.

Moreover, a number specification can also comprise both the specified number exactly and a usual tolerance range, provided that this has not been explicitly excluded.

The following detailed description refers to the accompanying drawing that show, by way of illustration, specific details and embodiments in which the disclosure may be practiced.

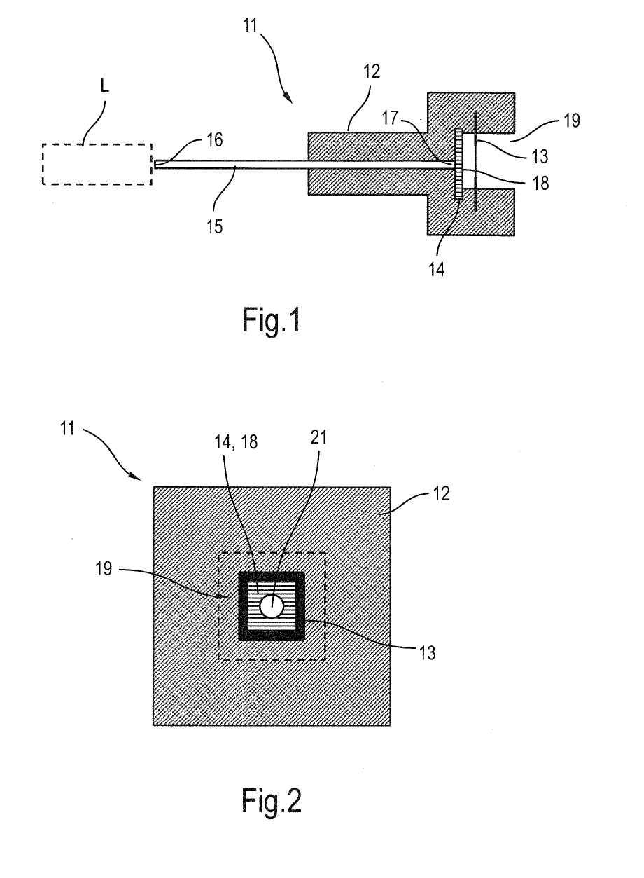

FIG. 1 shows, as a sectional illustration and in a side view, a remote phosphor converter apparatus 11 having an injection-molded holder 12 made of plastics with a reference element 13 visible from the outside, at least one transmitted-light converter element 14 held by the holder 12 and at least one primary light emitter element, held by the holder 12, in the form of an optical fiber 15. The transmitted-light converter element 14 is present in the foiw of a thin phosphor plate. The optical fiber 15 can, at the outside end 16 thereof, be optically coupled to a semiconductor light source L. The transmitted-light converter element 14 is therefore arranged at a distance from the semiconductor light source L, namely separated by the optical fiber 15. Here, the semiconductor source L is not part of the remote phosphor converter apparatus 11.

During operation of the converter apparatus 11, primary light is coupled into the outside end 16 of the optical fiber 15 from the semiconductor light source L and conducted to an inside end 17 of the optical fiber 15. The inside end 17 is situated close to a rear side of the transmitted-light converter element 14 or contacts the latter. It follows that the primary light is radiated onto the transmitted-light converter element 14 by the optical fiber 15 from the inside end 17 and passes through the former. During the passage, part of the primary light is converted into wavelength-converted secondary light. White mixed light made of primary light and secondary light then emerges from a front side 18 of the transmitted-light converter element 14. By way of example, the primary light may be blue light and the transmitted-light converter element 14 may have a phosphor which can convert blue light into yellow light such that, downstream of the transmitted-light converter element 14, the result of this is a blue-yellow or white mixed light.

The holder 12 is embodied as a housing, in which the transmitted-light converter element 14 is housed. A light emergence opening 19 for the mixed light to emerge is situated on the front side of the transmitted-light converter element 14. The reference element 13 is situated in the light emergence opening 19 and embedded in the holder 12.

FIG. 2 shows a frontal view against a light emission direction, i.e. viewing into the light emergence opening 19, of the remote phosphor converter apparatus 11. The reference element 13 is embodied as a square frame and visible from the outside through the light emergence opening 19. A round used light spot 21 on the front side 18 of the transmitted-light converter element 14 is smaller than an inner section of the reference element 13 such that the reference element 13 does not serve as a stop. The center of the reference element 13 (having a square embodiment in this case) also defines the center of the used light spot and thus serves as light-technical reference. However, in the case of a smaller cutout of the reference element 13, the latter can also additionally serve as pinhole or artificial edge.

The light emergence opening 19 may be covered by means of a light-transmissive, in particular transparent, protective cover (not illustrated).

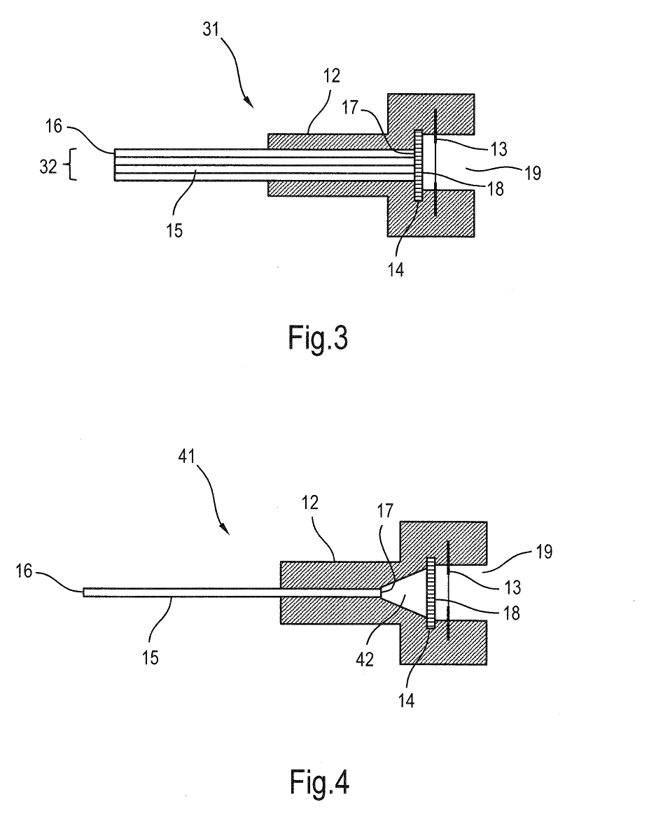

FIG. 3 shows, as a sectional illustration and in a side view, a remote phosphor converter apparatus 31 in accordance with a second exemplary embodiment. The converter apparatus 31 has a similar design to the converter apparatus 11, except that now it is not only an optical fiber 15 which serves as primary light emitter element, but rather an optical fiber bundle 32 of several optical fibers 15. The optical fibers 15 can be connected to a common semiconductor source or to different semiconductor sources. The optical fibers 15 of the optical fiber bundle 32 can have a sum used light spot composed, as desired, from the respective used light spots 21.

FIG. 4 shows, as a sectional illustration and in a side view, a remote phosphor converter apparatus 41 in accordance with a third exemplary embodiment. The converter apparatus 41 has a similar design to the converter apparatus 11, wherein, now, however, the inside end 17 is at a distance from the transmitted-light converter element 14. To this end, provision is made for a cavity 42 which expands from the inside end 17 to the transmitted-light converter element 14. The converter apparatus 41 is advantageous in that the transmitted-light converter element 14 cannot be damaged by contact with the optical fiber 15. Moreover, this renders it possible, in a simple manner, to obtain a larger used light spot 21. A coolant, e.g. air, can flow through the cavity 42 (not illustrated).

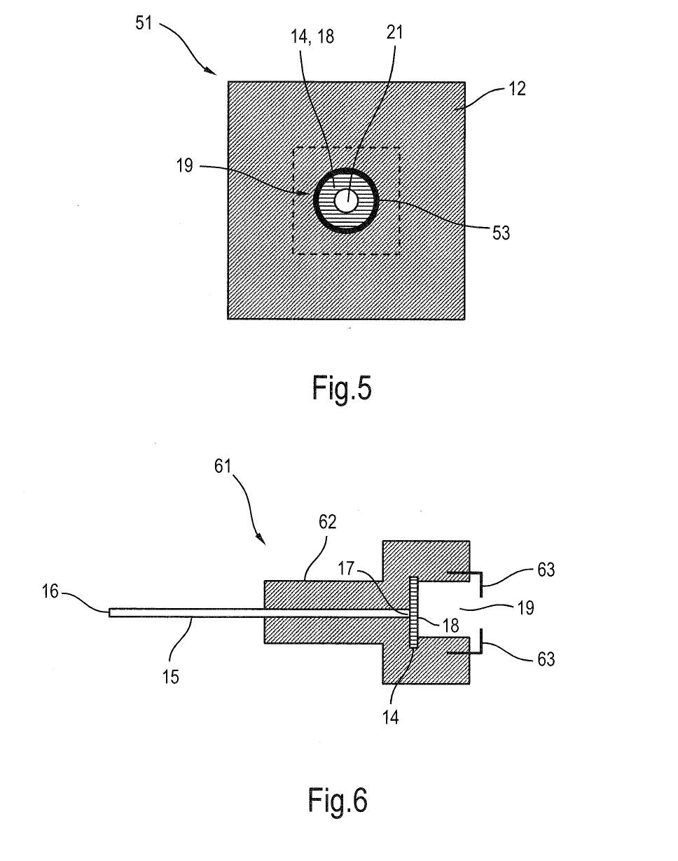

FIG. 5 shows a frontal view of a remote phosphor converter apparatus 51 in accordance with a fourth exemplary embodiment. In contrast to the converter apparatus 11 shown in FIG. 2, the reference element 53 is embodied as a circular frame and hence the contour thereof conforms to the used light spot 21.

FIG. 6 shows, as a sectional illustration and in a side view, a remote phosphor converter apparatus 61 in accordance with a fifth exemplary embodiment. The reference elements 63 are now not embedded in the light emergence opening 19, but rather are embedded in the holder 62 on the front side, in front of the light emergence opening 19. This enables more varied forming of the reference elements 63 and, moreover, is easier to produce.

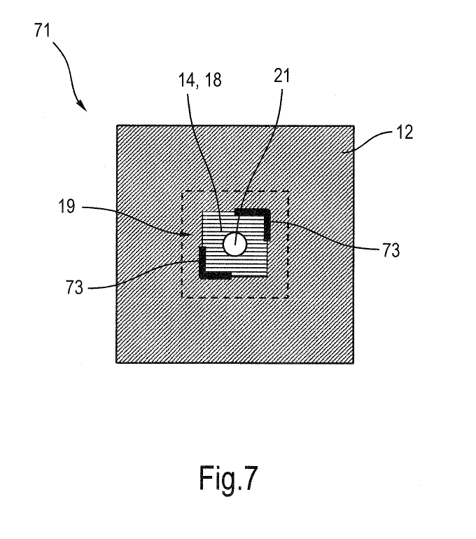

FIG. 7 shows a frontal view of a remote phosphor converter apparatus 71 in accordance with a sixth exemplary embodiment. Here, use is made of two reference elements 73 which are not interconnected and are visible as brackets. Here, the brackets form the corners of a square which, as described in relation to

FIG. 1, may serve as light-technical reference or reference marker.

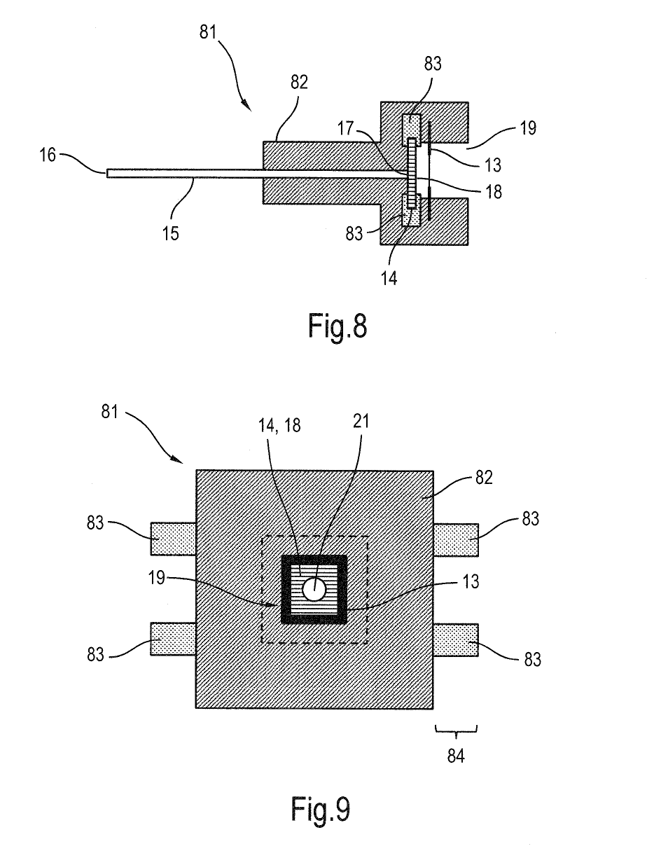

FIG. 8 shows, as a sectional illustration and in a side view, a remote phosphor converter apparatus 81 in accordance with a seventh exemplary embodiment. In addition to the converter apparatus 11, two strip-shaped heat conducting elements 83 are now embedded in the holder 82. By way of example, the heat conducting elements 83 can consist of metal such as aluminum or steel, of ceramic or of sapphire. The heat conducting elements hold the transmitted-light converter element 14 and are therefore in direct and also thermal contact therewith.

Moreover, as shown in FIG. 9, the heat conducting elements 83 are guided out of the holder 82 and can emit heat to the surroundings and/or be connected to a cooling body at their guided-out regions 84. Moreover, the guided-out regions 84 are suitable for attaching the converter apparatus 81.

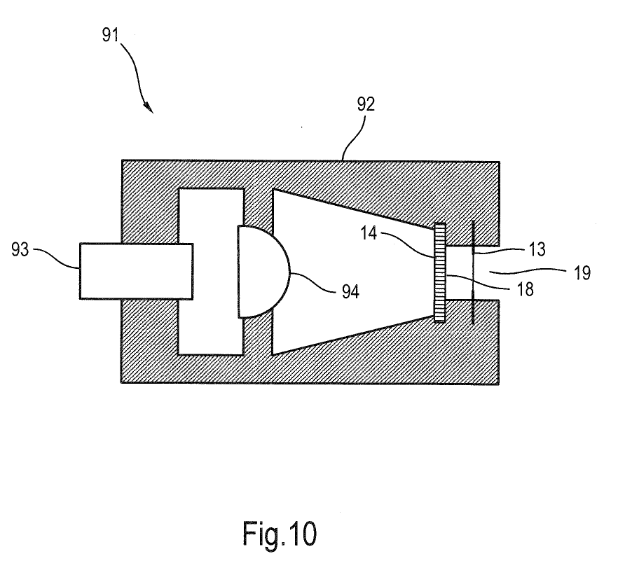

FIG. 10 shows, as a sectional illustration and in a side view, a remote phosphor converter apparatus 91 in accordance with an eighth exemplary embodiment. In this converter apparatus 91, there is no optical fiber for transmitting light from a semiconductor light source to the transmitted-light converter element 14. Rather, a semiconductor light source, here in the form of a laser 93, in particular a laser diode, is inserted into the holder 92 and held by the latter. The laser 93 radiates primary light onto an optical transmitted-light element which is in the form of a lens 94 and held in the holder 92. The lens 94 focuses the primary light onto the transmitted-light converter element 14. In accordance with the other exemplary embodiments, it is also possible, in this case, for a reference marker to be embedded and/or injected therein and/or pushed thereon (not illustrated).

Although the disclosure has been illustrated and described in more detail by means of the exemplary embodiments shown, the disclosure is not restricted to this and other variations can be derived from this by a person skilled in the art without departing from the scope of protection of the disclosure.

### List of Reference Signs

11 Remote phosphor converter apparatus
12 Holder
13 Reference element
14 Transmitted-light converter element
15 Optical fiber
16 Outside end of the optical fiber
17 Inside end of the optical fiber
18 Front side of the transmitted-light converter element
19 Light emergence opening
21Used light spot
31 Remote phosphor converter apparatus
32 Optical fiber bundle
41 Remote phosphor converter apparatus
42 Cavity
51 Remote phosphor converter apparatus
53 Reference element
61 Remote phosphor converter apparatus
62 Holder
63 Reference element
71 Remote phosphor converter apparatus
73 Reference element
81 Remote phosphor converter apparatus
82 Holder
83 Heat conducting element
84 Regions of the heat conducting element guided out of the holder
91 Remote phosphor converter apparatus
92 Holder
93 Laser
94 Lens
L Semiconductor light source

1. A remote phosphor converter apparatus comprising:
a holder with at least one reference visible from the outside,
at least one converter element held by the holder, and
at least one primary light emitter element which is held by the holder and configured to direct primary light emitted thereby to the converter element.

2. The remote phosphor converter apparatus as claimed in claim 1, wherein the converter element is a converter transmitted-light element.

3. The remote phosphor converter apparatus as claimed in claim 1, wherein the at least one reference is a reference element held by the holder.

4. The remote phosphor converter apparatus as claimed in claim 1, wherein the at least one reference is embodied as a pinhole for light emitted by the converter element.

5. The remote phosphor converter apparatus as claimed in claim 1, wherein the at least one primary light emitter element has at least one optical fiber.

6. The remote phosphor converter apparatus as claimed in claim 5, wherein the at least one optical fiber directly adjoins the converter element.

7. The remote phosphor converter apparatus as claimed in claim 5, wherein the at least one optical fiber is arranged at a distance from the converter element.

8. The remote phosphor converter apparatus as claimed in claim 1, wherein the at least one primary light emitter element has at least one semiconductor light source which is arranged at a distance from the converter element.

9. The remote phosphor converter apparatus as claimed in claim 8, wherein the holder holds at least one optical element arranged between the semiconductor light source and the converter element.

10. The remote phosphor converter apparatus as claimed in claim 1, wherein the holder is an injection molded part.

11. The remote phosphor converter apparatus as claimed in claim 1, wherein the holder is embodied as a housing, in which the at least one converter element is accommodated and in which there is at least one light emergence opening for light emitted by the at least one converter element.

12. The remote phosphor converter apparatus as claimed in claim 11, wherein the at least one reference is arranged in the region of the at least one light emergence opening.

13. The remote phosphor converter apparatus as claimed in claim 1, wherein the holder has at least one heat conducting element thermally connected to the at least one converter element, which heat conducting element is arranged at least in part on the outside of the holder.

14. An illumination device, comprising at least one remote phosphor converter apparatus, the remote phosphor converter apparatus comprising:
a holder with at least one reference visible from the outside,
at least one converter element held by the holder, and
at least one primary light emitter element which is held by the holder and
configured to direct primary light emitted thereby to the converter element.
